(19) United States
(12) Patent Application Publication
(10) Pub. No.: US 2008/0204501 A1
(43) Pub. Date: Aug. 28, 2008

(54) INKJET PRINT HEAD PRESSURE REGULATOR

(76) Inventors: Shinichi Kurita, San Jose, CA (US); Izya Kremerman, Los Gatos, CA (US)

Correspondence Address: DUGAN & DUGAN, PC, 245 Saw Mill River Road, Suite 309, Hawthorne, NY, 10532, US

(21) Appl. No.: 11/949,754

(22) Filed: Dec. 3, 2007

Related U.S. Application Data
(60) Provisional application No. 60/868,313, filed on Dec. 1, 2006.

(51) Int. Cl. B41J 2/01; B41J 29/38

(52) U.S. Cl. 347/17; 347/85

(57) ABSTRACT

An apparatus for use with an inkjet delivery system that comprises a negative pressure mechanism proximate to an inkjet print head that is adapted to apply a negative pressure on ink residing at the inkjet print head, and a controller coupled to the negative pressure mechanism that is adapted to controllably set the negative pressure on the ink at the inkjet print head.

### RELATED APPLICATIONS

The present application claims priority from U.S. Provisional Patent Application Ser. No. 60/868,313 entitled “INKJET PRINT HEAD PRESSURE REGULATOR,” filed Dec. 1, 2006, which is hereby incorporated by reference herein in its entirety.

This application is related to U.S. patent application Ser. No. 11/535,475 entitled “INKJET DELIVERY MODULE,” filed Sep. 26, 2006, which is incorporated herein by reference in its entirety.

### FIELD OF THE INVENTION

Embodiments of the present invention generally relate to substrate processing apparatuses and methods, such as apparatuses and methods for flat panel display processing (e.g., LCD, OLED, and other types of flat panel displays), semiconductor wafer processing, solar processing, etc.

### BACKGROUND

Inkjet printing systems for manufacturing flat panel displays and associated ink delivery systems may include numerous interrelated systems and apparatus that are complex and involve a substantial number of components and interconnections. This complexity may impact certain manufacturing design considerations as well as performance. Thus, what is needed are methods and apparatus that both improve the design of printing systems and improve performance (e.g., minimize any performance impacts).

### SUMMARY OF THE INVENTION

According to one aspect, the present invention provides an apparatus for use with an inkjet delivery system that comprises a negative pressure mechanism proximate to an inkjet print head that is adapted to apply a negative pressure on ink residing at the inkjet print head and a controller coupled to the negative pressure mechanism that is adapted to controllably set the negative pressure on the ink at the inkjet print head.

According to another aspect, the present invention provides an inkjet printing system that comprises a plurality of inkjet print heads and a head pneumatic module proximate to and coupled to the plurality of print heads. The head pneumatic module comprises, in turn, a negative pressure mechanism proximate to an inkjet print head that is adapted to apply a negative pressure on ink residing at the inkjet print head. The inkjet printing system may further include a controller coupled to the negative pressure mechanism of the head pneumatic module that is adapted to controllably set the negative pressure on the ink at the inkjet print head.

According to a further aspect, the present invention provides a method of controlling pressure on ink at an inkjet print head in an inkjet printing system that comprises producing a negative pressure on the ink at the inkjet print head, and monitoring the negative pressure to produce a set pressure on the ink.

### BRIEF DESCRIPTION OF THE DRAWINGS

FIG. 1A illustrates a perspective view of an inkjet printing system according to an embodiment of the present invention.

FIG. 1B illustrates a front schematic view of an embodiment of an ink delivery module according to the present invention.

FIG. 2 illustrates an enlarged view of the inkjet head assembly module 202 provided in accordance with the present invention.

FIG. 3 illustrates a schematic view of the inkjet head assembly module 202 provided in accordance with the present invention.

FIG. 4A illustrates a more detailed schematic view of an embodiment of an inkjet head assembly module 202 according to the present invention.

FIG. 4B illustrates a schematic view of inkjet print heads 430a, 430b, 430c, head pneumatic module 440, and associated hardware (which may be enclosed in inkjet printing enclosure 20 of FIG. 1A) that may be used in conjunction with the present invention.

FIG. 5 depicts a schematic diagram of a portion of an embodiment of the present invention including a preferable fluid delivery mechanism.

FIG. 6 depicts a block diagram of an exemplary method of controlling the pressure in an ink reservoir.

### DETAILED DESCRIPTION

In the manufacture of flat panel displays, to achieve accurate printing results with inkjet printing systems, it may be important for the shape of an ink droplet ejected from an inkjet print head to be as spherical as possible. The inventors of the present invention have determined that the pressure within an ink reservoir supplying ink to an inkjet print head, as well as the shape of the ink's meniscus within an inkjet print head nozzle, impact the shape of an ink droplet ejected from the nozzle. Accordingly, the present invention provides methods and apparatus for effectively controlling these variables to achieve accurate printing results.

The present invention provides methods and apparatus for controlling the pressure in an ink reservoir supplying ink to a print head. While in some embodiments, the pressure in such an ink reservoir may be controlled remotely from the print head, the inventors of the present invention have determined that in such remote controlled embodiments there may be a delay from the instant the apparatus attempts to adjust the pressure in the reservoir and the instant when the pressure actually changes. For example, the apparatus may attempt to adjust the reservoir pressure when a drop of ink is forced from a nozzle on the inkjet print head. There may be a delay sufficient to affect the next drop or delay the time until the next drop may be forced from the nozzle. In some embodiments, the delay may be due to the time it takes for a pressure wave in a fluid (e.g., air, water, etc.) produced by the adjustment to reach the ink reservoir. This reduces the accuracy and response time of controlling the ink reservoir pressure and therefore the accuracy of controlling the shape of the ink drop.

To improve the accuracy and response time of controlling the ink reservoir pressure and the shape of the ink drop, according to the present invention, a head pneumatic module is provided on an inkjet print head assembly, proximate to the print head. The head pneumatic module may precisely control both the pressure in the ink reservoir and the shape of the ink's meniscus within a print head nozzle, thereby precisely controlling factors that effect the shape of an ink droplet. In addition, the location of the head pneumatic module relative to the ink reservoir may reduce the response time and increase the accuracy of maintaining pressure within the reservoir.

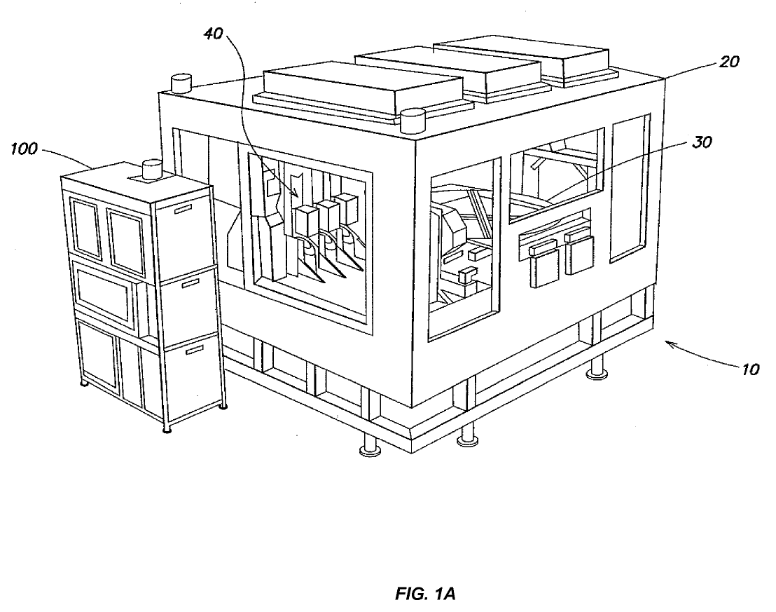

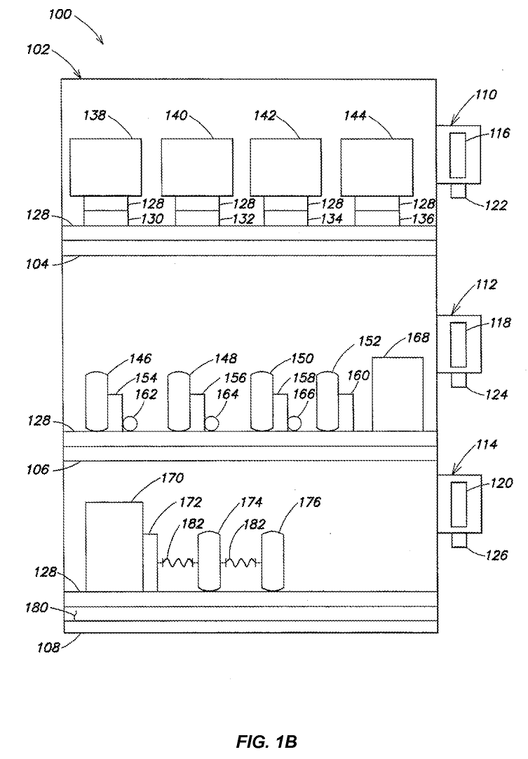

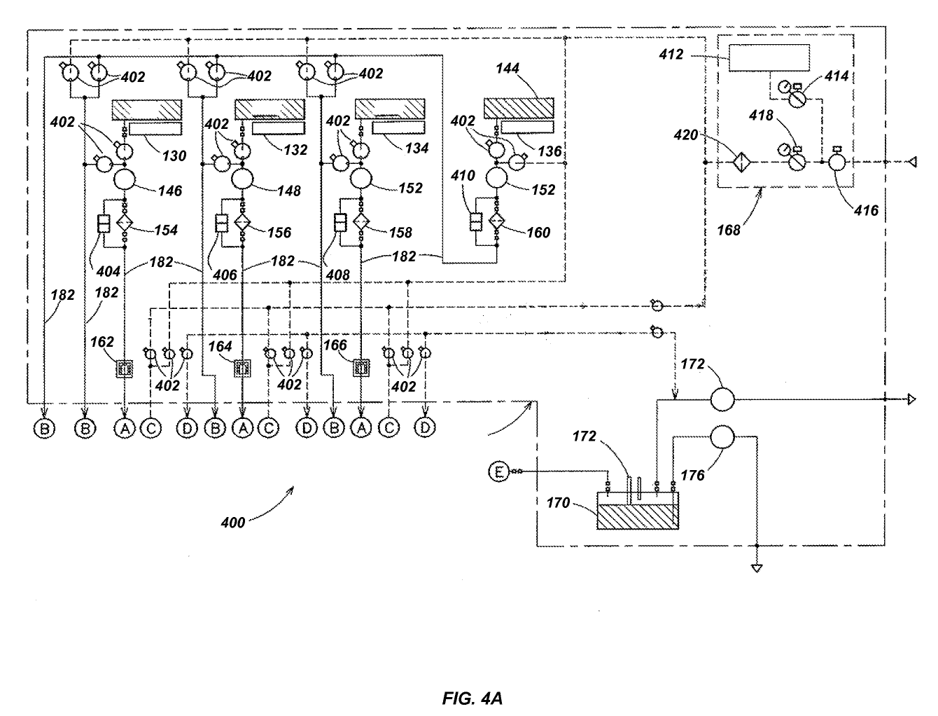

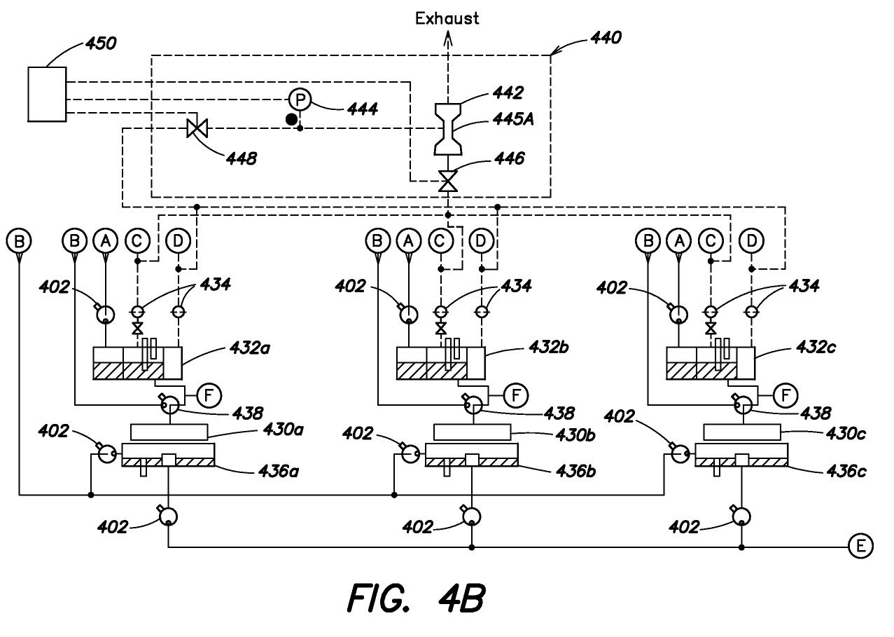

FIG. 1A illustrates a perspective view of an embodiment of an inkjet printing system according to the present invention. The inkjet printing system 10 may include an inkjet printing enclosure 20, which may provide a clean environment for inkjet printing. Enclosed in inkjet printing enclosure 20 may be inkjet station 30. The inkjet station 30 may provide means (e.g., motors) for positioning an inkjet print head assembly 40. Inkjet print head assembly 40 may include one or more inkjet print heads and a head pneumatic module (described below in relation to FIG. 4B). Ink delivery module 100, which is further described in FIG. 1B, may be coupled (e.g., in fluid communication and/or electrically) to the inkjet printing system 10.

FIG. 1B illustrates a front schematic view of an embodiment of an ink delivery module 100 according to the present invention, which is designated generally by the reference numeral 100. In an exemplary embodiment, the ink delivery module 100 of the present invention may include an enclosure 102, which may include shelves 104, 106, and 108. Coupled to the enclosure 102 may be doors 110, 112, and 114. Doors 110, 112, 114 may include windows 116, 118, and 120 and/or door close sensors 122, 124, and 126. Shelves 104, 106, 108 may each support a leak sensor 128.

Supported on shelf 104 may be one or more scales 130, 132, 134, and 136. Scales 130, 132, 134, 136 may in turn each support a leak sensor 128. Also supported on scales 130, 132, 134 may be one or more ink reservoirs 138, 140, and 142. Scale 136 may support a solvent reservoir 144 similarly.

Supported on shelf 106 and coupled to ink reservoirs 138, 140, 142 may be ink pumps 146, 148, and 150, respectively. Similarly, a solvent pump 152 may be coupled to the solvent reservoir 144 and may be supported on shelf 106. Coupled respectively to ink pumps 146, 148, 150 and also supported on shelf 106 may be ink filters 154, 156, and 158. A solvent filter 160 may be supported on shelf 106 and coupled to solvent pump 152. Ink filters 154, 156, 158 may each have a sonicator 162, 164, and 166 coupled thereto, which may also be supported on shelf 106. Also supported on shelf 106 may be a purge control unit 168.

Supported on shelf 108 may be a drain tank 170, which may include a drain tank level sensor 172. Coupled to drain tank 170 and supported on shelf 108 may be an exhaust pump 174 and a drain pump 176. Above or beneath shelf 108 may be a spill pan 180. Tubes 182 may connect components in fluid connection with each other in enclosure 102.

In the exemplary embodiment of FIG. 1B, the enclosure 102 may be constructed of a sturdy material (e.g., steel sheet metal) in a manner that prevents leakage to the environment outside the enclosure 102. Shelves 104, 106, 108 and doors 110, 112, 114 may be constructed of similar materials. Windows 116, 118, 120 may be constructed of a fire resistant window material.

Leak sensors 128 may be any type of sensor capable of detecting fluid leakage. For example, an optical liquid leak detector may be used.

Scales 130, 132, 134, 136 may be capable of detecting any range of mass, preferably measuring about six to ten kilograms of liquid ink and/or solvent. Scales 130, 132, 134, 136 may have high resolution (e.g., less than 0.1 grams) and linearity (e.g., +/−0.1 grams), though any appropriate resolution and/or linearity may be used.

Ink reservoirs 138, 140, 142 and solvent reservoir 144 preferably are of sufficient size to require refill or replacement about every two to seven days, though any appropriate capacity (e.g., 1, 2, 3, 4, 5, 6, etc. liter) or shape (e.g., cube, bottle, sphere, etc.) container may be used. Ink pumps 146, 148, 150 may include peristaltic pumps, though any appropriate type of pump may be used. In a particular embodiment, an ink pump capable of a flow speed of about 1-5 cc/sec with a flow pressure of about 6+/−1 psi at the inkjet print head may be used. Other pumps with different flow speeds, flow pressures, and/or other performance characteristics may be used.

Solvent pump 152 may include a diaphragm pump, though any appropriate type of pump may be used. In a particular embodiment, a pump capable of a flow speed of about 10 cc/sec with a flow pressure of about 6+/−1 psi at the inkjet print head may be used. Other pumps with different flow speeds, flow pressures, and/or other performance characteristics may be used.

Ink filters 154, 156, 158 and solvent filter 160 preferably are capable of filtering particles of about 1 micron in size or larger, though filters capable of filtering larger or smaller particles may be used as appropriate. Filters 154, 156, 158 may be constructed of any suitable material, such as Teflon®, polypropylene, or nylon. Ink filters 154, 156, 158 and solvent filter 160 may, in some embodiments, be quick replacement filters.

Sonicators 162, 164, 166 may be any sonic processor, such as a megasonic processor, an ultrasonic processor, or a processor designed to act in another frequency range.

Drain tank 170 may be constructed of any suitable material (e.g., stainless steel) and preferably has a capacity of at least about 10 liters and may maintain a pressure of about less than 100 Torr. Other materials, capacities, or pressures may be used when appropriate. Drain tank level sensor 172 may be any sensor capable of detecting a level in the drain tank 170, such as a capacitance sensor.

Exhaust pump 174 may include a diaphragm pump, though any appropriate type of pump may be used. In a particular embodiment, a pump capable of a flow speed of about more than 15 slm with a base pressure of about less than 100 Torr may be used. Other pumps with different flow speeds, base pressures, and/or other performance characteristics may be used.

The spill pan 180 may be of sufficient size to contain any spilled material, preferably with a minimum depth of about two inches and able to contain at least about 110% of the contents of an ink reservoir 138, 140, 142.

Tubes 182 may be constructed of a sturdy material resistant to corrosion, such as Teflon®, though any appropriate material may be used. They may be of a dark color, such as black, to provide UV protection. The tubes 182 for use with pneumatic lines may also be constructed of nylon or a similar material.

In operation, enclosure 102 may be a cabinet or similar structure that may include one or more shelves 104, 106, 108. Shelves 104, 106, 108 may be capable of supporting any number of components for use in conjunction with an inkjet printer. Though three shelves 104, 106, 108 are shown in FIG. 1B, it is noted that any appropriate number of shelves may be used to divide, support, and contain any components in enclosure 102. Shelves 104, 106, 108 may be positioned horizontally with components situated above or below the shelves 104, 106, 108 or may be positioned at any other angle. Enclosure 102 may preferably be capable of functioning as an exhaustible enclosure. That is, enclosure 102 may be sealable in a manner that will prevent materials (e.g., ink, solvent, gases) from leaking out of the enclosure.

Access to the sealed enclosure 102 may be gained through one or more doors 110, 112, 114. Doors 110, 112, 114 may be attached to or hinged to enclosure 102 and/or may be removable. Any number of doors 110, 112, 114 may be used for access to enclosure 102 and may be sectioned or hinged in manners that allow access to a portion of enclosure 102 without compromising the seal of the remaining portion of the enclosure 102. In the exemplary embodiment of FIG. 1B, door 110 may provide access to replace ink and/or solvent in ink reservoirs 138, 140, 142 and solvent reservoir 144. Door 112 may provide access for maintenance of pumps 146, 148, 150, 152 and/or purge control 168. Similarly, door 114 may provide access for maintenance of drain tank 170. As discussed above, any number of doors may be used to gain access to enclosure 102 and may provide for and/or support sealed portions of the enclosure 102.

Doors 110, 112, 114 may each include one or more windows 116, 118, 120 for monitoring components inside exhausted enclosure 102. Any appropriate number and location of windows may be used to monitor system performance (e.g., pump motion, scales, ink and/or solvent levels, drain tank condition, etc.). To ensure closure of doors 110, 112, 114 and/or sealing of enclosure 102, the ink delivery module 100 may include one or more door close sensors 122, 124, 126. Door close sensors 122, 124, 126 may be capable of detecting various alarm conditions. For example, door close sensors 122, 124, 126 may detect any of doors 110, 112, 114 ajar or open and/or materials (e.g., fluids and/or gases) escaping enclosure 102 at or about doors 110, 112, 114.

Enclosure 102 may house any number of leak sensors 128, preferably at least seven (as described below). Leak sensors 128 may be located on each of shelves 104, 106, 108, beneath each of ink reservoirs 138, 140, 142 and solvent reservoir 144, and/or any location within enclosure 102 where fluids may leak. Though discussed herein as being disposed on shelves 104, 106, 108 and beneath reservoirs 138, 140, 142, 144, one or more leak sensors 128 may be positioned below shelves 104, 106, 108, in reservoirs 138, 140, 142, 144, or any other suitable location.

Scales 130, 132, 134, 136 may support ink reservoirs 138, 140, 142 and/or solvent reservoir 144 and may serve to indicate the amount of ink and/or solvent used. For example, if ink reservoir 138 filled to a four-liter capacity sits atop scale 130, the scale 130 may be calibrated to only display the weight of the liquid in ink reservoir 138. As the ink is pumped from the ink reservoir 138, scale 130 may display a decreasing weight corresponding to the amount of ink remaining in ink reservoir 138. Scales 132, 134, 136 may operate similarly. In an alternative embodiment, scales 132, 134, 136 may be calibrated so as to display the weight of the container and any materials contained within it.

One or more ink reservoirs 138, 140, 142 may be capable of containing ink to be dispensed from an inkjet print head (shown in FIG. 4B). Ink reservoirs 138, 140, 142 may each contain a separate color ink (for example, ink reservoir 138 may contain blue ink, ink reservoir 140 may contain green ink, ink reservoir 142 may contain red ink) or may all contain the same color ink. Though depicted in FIG. 1B as independent reservoirs, ink reservoirs 138, 140, 142 may be an integrated or otherwise attached unit.

Solvent reservoir 144 may be adapted to contain a solvent (e.g., PGMEA, acetone, or the like) for use in inkjet printing. Solvent reservoir 144 may be in fluid communication with ink reservoirs 138, 140, 142, inkjet print heads (shown in FIG. 4B), or any other lines and/or components in the inkjet printing system and/or inkjet delivery module 100. Solvent from solvent reservoir 144 may be used to purge lines and/or components associated with the inkjet printing system subsequent to replacement of tubes and/or components. In such embodiments, the solvent may be purged via a purge gas (e.g., N2, H2, filtered air, or the like).

Ink may be pumped from ink reservoirs 138, 140, 142 by corresponding ink pumps 146, 148, 150. In alternative embodiments, any number of ink pumps 146, 148, 150 may be used (e.g., a single pump for all ink reservoirs 146, 148, 150). Ink pumps 146, 148, 150 may be peristaltic pumps, or may be any other pump capable of pumping ink from ink reservoirs 138, 140, 142 to inkjet print heads (shown in FIG. 4B).

Ink pumped from ink reservoirs 138, 140, 142 by pumps 146, 148, 150 may be pumped through respective ink filters 154, 156, 158. Ink filters 154, 156, 158 may filter particulate matter from the ink.

Ink pumped from ink reservoirs 138, 140, 142 by pumps 146, 148, 150 may also be flown through sonicators 162, 164, 166. Sonicators 162, 164, 166 may be capable of breaking up or dissolving particulate matter in ink transferred from ink reservoirs 138, 140, 142. Devices which may be used as sonicators 162, 164, 166 are described in pending U.S. patent application Ser. No. 11/061,122 titled “Methods and Apparatus for Reducing Ink Conglomerates during Inkjet Printing for Flat Panel Display Manufacturing” filed Feb. 8, 2005, which is incorporated herein by reference in its entirety. Alternatively, sonicators 162, 164, 166 may be coupled at other locations such as directly coupled to the ink reservoirs 138, 140, 142 so as to reduce ink conglomerates therein. In an exemplary embodiment, an ultrasonic device may be used to break apart conglomerates in ink from ink reservoirs 138, 140, 142.

The purge control unit 168 may be coupled in a manner to allow ink and/or solvent to be purged from any or all components contained in the enclosure 102 or coupled thereto (e.g. inkjet print heads and the head pneumatic module operating outside the enclosure 102, both shown in FIG. 4B). The purge control unit 168 may assist in flowing a gas to one or more components contained within enclosure 102.

The drain tank 170 may be adapted to receive fluids and/or gasses flowed from components inside enclosure 102 and may be further adapted to receive fluids and/or gasses from outside enclosure 102. The drain tank 170 may serve as a holding tank to contain these fluids and/or gasses until they are transferred to a supporting system (e.g., an exhaust system or a drain facility that services a larger portion of the processing facility, such as a house exhaust system). In one or more embodiments, the drain tank 170 may be removable so that it may be drained of its contents and/or replaced with another drain tank 170.

To determine the level of fluids contained in drain tank 170, a drain tank level sensor 172 may be coupled thereto. In an exemplary embodiment, the drain tank level sensor may be capable of determining a level of fluids within the drain tank 170 and displaying the current level at the drain tank 170. In the same or alternative embodiments, the drain tank level sensor may be capable of determining the level of fluids in the drain tank 170 and relaying the level to an entity outside the enclosure 102 (e.g., a control panel, an external level indicator, a remote meter, etc.). In still other embodiments, the drain tank level sensor 172 may be adapted to cause an alarm to be triggered when the level of fluids in the drain tank 170 exceeds a pre-set level.

The exhaust pump 174 may be adapted to pump exhaust from the drain tank 170. In an exemplary embodiment, the exhaust pump 174 may be coupled to the drain tank 170 and be capable of pumping gasses contained within the drain tank 170 outside of enclosure 102 (e.g., pumping gasses to a house exhaust system).

The drain pump 176 may be similarly coupled to the drain tank 170. In an exemplary embodiment, the drain pump 176 may be coupled to the drain tank 170 and be capable of pumping fluids contained within the drain tank 170 outside of enclosure 102 (e.g., pumping fluids to a drain facility).

The spill pan 180 may be adapted to contain fluids that spill, leak, or are otherwise deposited within enclosure 102. In an exemplary embodiment, the spill pan 180 may be removable from enclosure 102 for drainage and/or replacement. In the same or alternative embodiments, spill pan 180 may be removable from enclosure 102 without tampering with the seal of the exhausted enclosure as described above.

Tubes 182 may fluidly connect components within enclosure 102 and/or may provide fluid connection to components outside of enclosure 102 (e.g., the inkjet print heads and the head pneumatic module of FIG. 4B). In an exemplary embodiment, tubes 182 may fluidly connect ink reservoirs 138, 140, 142 to inkjet print heads 430a, 430b, 430c and the head pneumatic module (shown in FIG. 4B) through ink pumps 146, 148, 150, ink filters 154, 156, 158, and/or sonicators 162, 164, 166. In the same or alternative embodiments, tubes 182 may fluidly connect solvent reservoir 144 with ink reservoirs 138, 140, 142. In still other embodiments, tubes 182 may provide fluid connection of the head pneumatic module (shown in FIG. 4B) with inkjet print heads (shown in FIG. 4B) and/or purge control unit 168. Similarly, purge control unit 168 may be fluidly connected via tubes 182 with ink reservoirs 138, 140, 142, solvent reservoir 144, or any other component within enclosure 102.

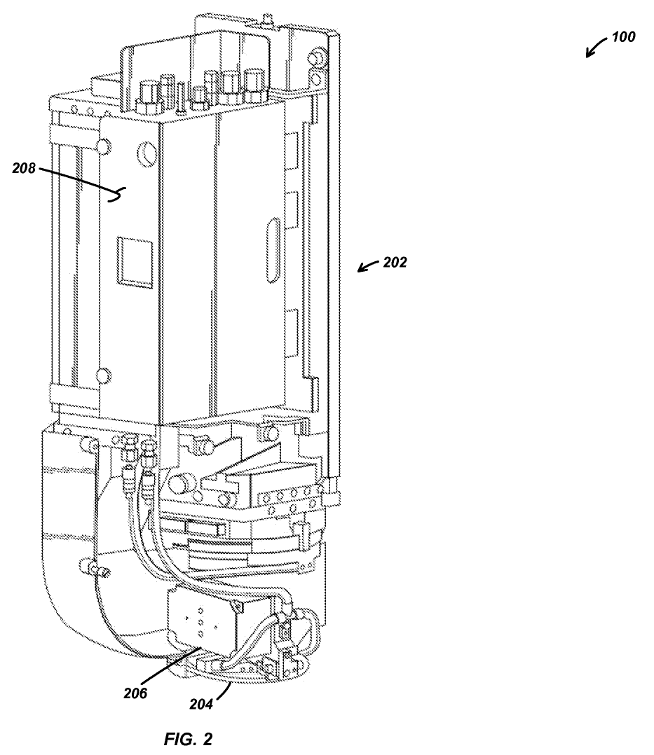

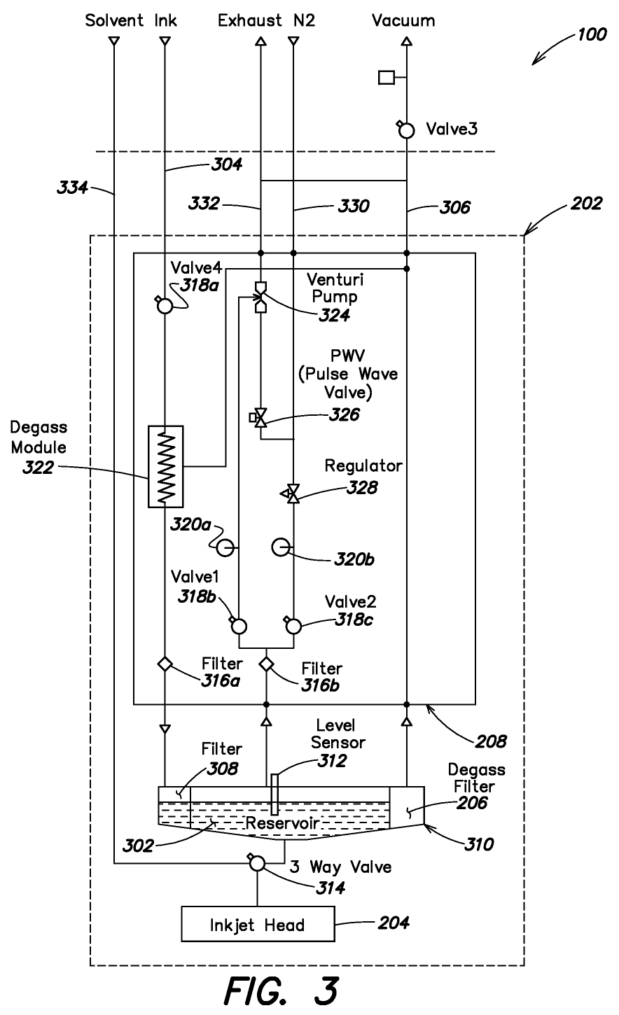

FIG. 2 illustrates an enlarged view of the inkjet head assembly module 202 provided in accordance with the present invention. The inkjet head assembly module 202 includes an inkjet module print head 204 that is coupled to the inkjet head assembly module 202. A reservoir pneumatic module 208 may be disposed on the inkjet head assembly module 202. The inkjet module print head 204 is coupled to the inkjet module assembly reservoir 206 which is described with reference to the following FIGS. 3 to 5.

The inkjet module print head 204 is adapted to dispense drops of ink onto a substrate in a manner as described above with reference to FIGS. 1A and 1B. The inkjet module print head 204 may receive ink from the inkjet module assembly reservoir 206. The inkjet module assembly reservoir 206 may be adapted to provide ink to the inkjet module print head 204. The inkjet module assembly reservoir 206 may also be coupled to a supply of ink in the ink delivery module 100. As depicted, the inkjet module assembly reservoir 206 is mechanically coupled to the inkjet module print head 204 although, in some embodiments, the reservoir 206 may not be mechanically coupled to the inkjet module print head 204. That is, the inkjet module assembly reservoir 206 may be situated close to the inkjet module print head 204 so as to allow the ink to be deposited in the desired manner as described above with reference to FIGS. 1A-2.

FIG. 3 illustrates a schematic view of the inkjet head assembly module 202 provided in accordance with the present invention. The inkjet module print head 204 is coupled to the inkjet module assembly reservoir 206 described with reference to FIG. 2 and contains ink 302. The ink 302 is supplied via the ink supply tube 304 that is coupled to the inkjet module assembly reservoir 206. The inkjet module assembly reservoir 206 is also coupled to the vacuum line 306 that provides vacuum. The inkjet module assembly reservoir 206 may include a reservoir module filter 308, reservoir module degassing filter 310, and reservoir module level 312. The inkjet module print head 204 may be coupled to the inkjet module assembly reservoir 206 via a three way valve 314. The reservoir pneumatic module 208 may include filters 316a-c, valves 318a-c, and/or meters 420a-b. The reservoir pneumatic module 208 may also include a degass module 422. The degass module 422 may be coupled to the filters 316a and valves 318a. The filters 316a may be coupled to the inkjet module assembly reservoir 206. The valves 318a may be coupled to the ink supply tube 304 that supplies ink to the inkjet module assembly reservoir 206. The reservoir pneumatic module 208 may also include a reservoir venturi pump 324 that is coupled to a reservoir pulse wave valve 326. The reservoir pulse wave valve 326 may be coupled to a reservoir regulator 328. The reservoir regulator 328 may be coupled to a purge line 330 (e.g., an N₂ purge line) and the reservoir venturi pump 324 may be coupled to an exhaust line 332. To supply solvent, a module solvent 334 may be coupled to the three way valve 314. The inkjet head assembly module 202 is described in more detail below with reference to FIGS. 4A-6.

FIG. 4A illustrates a more detailed schematic view of an embodiment of an inkjet head assembly module 202 according to the present invention. The inkjet head assembly module 202 of the present invention, in an exemplary embodiment, may include the components described above with reference to FIGS. 1A and 1B. Accordingly, description of these components is not repeated with reference to FIG. 4A.

As shown in FIG. 4A, the inkjet head assembly module 202 may also include control valves 402 coupled to tubes 182. Ink differential pressure sensors 404, 406, and 408 may be coupled in parallel with ink filters 154, 156, and 158. Similarly, solvent differential pressure sensor 410 may be coupled in parallel with solvent filter 160.

In operation, ink from ink reservoirs 138, 140, 142 may be flowed through a set of control valves 402, pumped by ink pumps 146, 148, 150. Control valves 402 may be adapted to control the flow of ink and/or other material through tubes 182. Similarly, solvent and/or other flushing fluids from solvent reservoir 144 may be flowed through a control valve 402, pumped by solvent pump 152. The control valve 402 may be adapted to control the flow of solvent and/or other material through tubes 182. Here, solvent from solvent reservoir 144 may be passed through further control valves 402 and flowed into tubes 182 (e.g., to flush ink). Ink and/or solvent may be pumped through ink pumps 146, 148, 150. In alternative embodiments, solvent may be flowed into the ink stream at another point (e.g., at the inkjet print heads of FIG. 4B and/or directly into ink reservoirs 138, 140, 142).

Ink and/or solvent may then be flowed through the ink filters 154, 156, 158 and/or ink differential pressure sensors 404, 406, 408. In an exemplary embodiment, ink filters 154, 156, 158 and ink differential pressure sensors 404, 406, 408 are arranged in parallel. Alternatively, ink filters 154, 156, 158 and ink differential pressure sensors 404, 406, 408 may be arranged in series. Ink differential pressure sensors 404, 406, 408 may be adapted to measure the pressure of ink and/or solvent flow at two points in a tube 182 and use these measurements to sense a difference in pressure.

In a similar manner, solvent flowed from solvent reservoir 144 may be flowed through the solvent filter 160 and/or solvent differential pressure sensor 410. In an exemplary embodiment, solvent filter 160 and solvent differential pressure sensor 410 are arranged in parallel. Alternatively, solvent filter 160 and solvent differential pressure sensor 410 may be arranged in series. Solvent differential pressure sensor 410 may be adapted to measure the pressure of solvent flow at two points in a tube 182 and use these measurements to sense a difference in pressure.

Ink and/or solvent may then be pumped to components outside the inkjet head assembly module 202 through lines A, for example. Solvent and/or a flushing fluid may be pumped to components outside the inkjet head assembly module 202 through lines B, for example.

Purge control unit 168, depicted in FIG. 1B, is shown in greater detail in FIG. 4A. The purge control unit 168 may include a valve assembly 412 coupled to a first regulator 414. The first regulator 414 may be coupled to a manual valve 416 and a second regulator 418. The second regulator 418 may in turn be coupled to a purge filter 420.

In an exemplary embodiment, valve assembly 412 may provide an increased pressure to a gas to be flowed to the first regulator 414. The valve assembly 412 may be any appropriate valve capable of helping to increase pressure, such as a solenoid pilot valve.

The first regulator 414 may be adapted to control the pressure applied by the valve assembly 412. In an exemplary embodiment, the first regulator 414 may hold gas flowed through a tube (not shown in FIG. 4A; see tubes 182 in FIG. 1B) at about 70 psi, although any appropriate pressure may be used.

A purge gas (e.g., N2, H2, filtered air, or the like) may be flowed from an outside source through manual valve 416, which may be capable of controlling the gas flow from the outside source. The manual valve 416 may have lockout and/or tagout capability. A purge gas flowed through manual valve 416 and gas received from the first regulator 414 may be further regulated by the second regulator 418. In an exemplary embodiment, the second regulator 418 may hold gas flowed through a tube (not shown in FIG. 4A; see tubes 182 in FIG. 1B, for example) at about 5 psi, although any appropriate pressure may be used.

After passing through the second regulator 418, the purge gas may be passed through a purge filter 420, which may filter the purge gas. In an exemplary embodiment, the purge filter 420 may be capable of filtering particulates from the purge gas of about 0.1 um or more. After being filtered by purge filter 420, the purge gas may be flowed through tubes (not shown in FIG. 4A; see tubes 182 in FIG. 1B, for example) to various components contained within the inkjet head assembly module 202 (e.g., to clear ink and/or solvent from tubes 182) and/or to components outside the inkjet head assembly module 202.

FIG. 4B illustrates a schematic view of inkjet print heads 430a, 430b, 430c, head pneumatic module 440, and associated hardware (which may be enclosed in inkjet printing enclosure 20 of FIG. 1A) that may be used in conjunction with the present invention. Inkjet reservoirs 432a, 432b, 432c may be coupled to inkjet print heads 430a, 430b, 430c via lines F. Inkjet reservoirs 432a, 432b, 432c may each be coupled to any number of filters 434. Inkjet print heads may reside at head stations 436a, 436b, 436c. Coupled between print heads 430a, 430b, 430c and inkjet reservoirs 432a, 432b, 432c may be 3-way valves 438.

Inkjet print heads 430a, 430b, 430c may be used in concert with the enclosure 102 of FIGS. 1B and 4A and directly or indirectly supplied ink and/or solvent through lines A and solvent through lines B. For example, ink and/or solvent may be flowed from the inkjet head assembly module 202 through lines A into inkjet reservoirs 432a, 432b, 432c, which may hold a quantity of ink and/or solvent until it is consumed by inkjet print heads 430a, 430b, 430c.

Compressed gas from purge control unit 168 or another source may be supplied to inkjet reservoirs 432a, 432b, 432c via lines C. Similarly, suction may be applied to inkjet reservoirs 432a, 432b, 432c via lines D.

Head pneumatic module 440 may include a venturi 442, a vacuum sensor 444, a control valve 446, and a shutoff valve 448. A controller 450 for valves 446, 448 may be situated outside of the head pneumatic module 440. The venturi 442 includes a constriction 445a. The venturi 442 has a high pressure inlet coupled to a first side, a suction line coupled to the constriction 445a, and an exhaust outlet coupled to a second side opposite from the first side. Venturi 442 may be fluidly connected to purge control unit 168 or another source of compressed gas, via lines C. Control valve 446 is coupled via the high pressure line to the first side of the venturi 442. Compressed gas may be supplied along the high pressure line from purge control unit 168 or another source. Constriction 445a is fluidly connected via the suction line to inkjet reservoirs 432a, 432b, 432c through lines D and shutoff valve 448. Vacuum sensor 444 is fluidly connected to constriction 445a, between shutoff valve 448 and constriction 445a. Controller 450 may be electrically connected to vacuum sensor 444, control valve 446, and shutoff valve 448.

The head pneumatic module 440 may be capable of receiving compressed gas from the purge control unit 168 or another source and generating a negative pressure at inkjet print heads 430a, 430b, 430c. In an exemplary embodiment, the head pneumatic module 440 may be capable of generating a negative pressure of about 0-5″ H₂O at the inkjet print heads 430a, 430b, 430c. In the same or other embodiments, the head pneumatic module 440 is further capable of controlling each inkjet print head independently. In at least one embodiment, the vacuum sensor 444 may provide feedback to control valve 446 via controller 450. The controller 450 may be capable of controlling the flow rate of gas flowed through control valve 446. This gas may be pumped from the purge control unit 168 or another source of compressed gas, to the head pneumatic module 440 at control valve 446, and through the venturi 442, to components outside the inkjet head assembly module 202, for example. In at least one embodiment, controller 450 may also be capable of controlling the flow of gas through shutoff valve 448 by controlling the same.

In operation, to assist the inkjet print heads 430a, 430b, 430c, a negative pressure may be applied by head pneumatic module 440 to inkjet reservoirs 432a, 432b, 432c via lines D. This negative pressure may be further applied to the inkjet print heads 430a, 430b, 430c via lines F, to prevent ink from leaking and/or being inadvertently discharged. In order to achieve such a negative pressure, gas may be flowed from the inkjet head assembly module 202 or another source of compressed gas, through lines C, control valve 446, and venturi 442, and then exhausted from the system. The suction generated at the constriction 445a of venturi 442 and applied at inkjet reservoirs 432a, 432b, 432c via lines D, while gas is flowed through venturi 442, may produce a negative pressure at inkjet print heads 436a, 436b, 436c sufficient for deterring ink leakage.

Additionally or alternatively, when 3-way valves are employed between inkjet print heads 430a, 430b, 430c and inkjet reservoirs 432a, 432b, 432c, the 3-way valves 438 may provide two supply paths to the inkjet print heads 430a, 430b, 430c. The first supply path may include ink flowed through lines F from the inkjet reservoirs 432a, 432b, 432c, which are used during normal inkjet printing operations. The second supply path may include a purge gas (e.g., nitrogen or filtered air) and/or a solvent (e.g., PGMEA) flowed to the 3-way valves 438 through lines B.

During a purge operation, ink inside inkjet print heads 430a, 430b, 430c may be purged by the purge gas and subsequently flushed with the solvent. The solvent may then remain in the inkjet print heads 430a, 430b, 430c until printing resumes to prevent clogging. To restart printing, the inkjet print heads 430a, 430b, 430c may be purged by the purge gas and/or solvent through 3-way valves 438 and subsequently supplied with ink from inkjet reservoir 430a, 430b, 430c through 3-way valves 438. In one embodiment, a long purge may be followed by a few short purges before printing resumes.

Should inkjet print heads 430a, 430b, 430c become clogged due to drying ink, the inkjet print heads 430a, 430b, 430c may be flushed by the purge gas and/or solvent to remove any solid deposit inside inkjet print heads 430a, 430b, 430c. The purge gas may force open one or more nozzles (not shown) of inkjet print heads 430a, 430b, 430c, allowing the solvent to access and dissolve any dried ink.

The 3-way valves 438 may be advantageous as they allow a gating to facilitate purging and unclogging of inkjet print heads 430a, 430b, 430c. Purging and unclogging inkjet print heads 430a, 430b, 430c may improve the lifetime of the part, thus reducing system cost. Additionally, 3-way valves 438 may consume less space than an analogous system using two 2-way valves, thus reducing the footprint of the system.

When inkjet print heads 430a, 430b, 430c are in residence at head stations 436a, 436b, 436c, any overflow, spilled, or otherwise excessive ink, solvent, and/or other fluids and/or gasses may be acquired and moved away from (e.g., pumped or siphoned from) the inkjet print heads 430a, 430b, 430c. This ink or other material may be flowed though lines E to be deposited in drain tank 170 (FIGS. 1B and 4A).

Other arrangements and/or methods and apparatus for conveyance may be used where appropriate including the addition of and/or elimination of certain components (e.g., pumps, valves, controllers, tubes, pressure devices, etc.) without departing from the scope of this invention. For example, in the alternative embodiment of FIG. 4B, gas pressure may be used as a fluid delivery mechanism to move ink instead of the pumps depicted in FIGS. 1B and 4A. The ink delivery module of the present invention, in an exemplary embodiment, may include the components described above with reference to FIGS. 1B and 4A. Accordingly, description of these components is not repeated with reference to FIG. 4B. Similarly, components ancillary to the particular workings of the embodiment of FIG. 4B are omitted for clarity. It is understood that these components (e.g., scales, valves, gauges, filters, etc.) depicted in FIGS. 1B and 4A may be used in the embodiment of FIG. 4B in any appropriate manner.

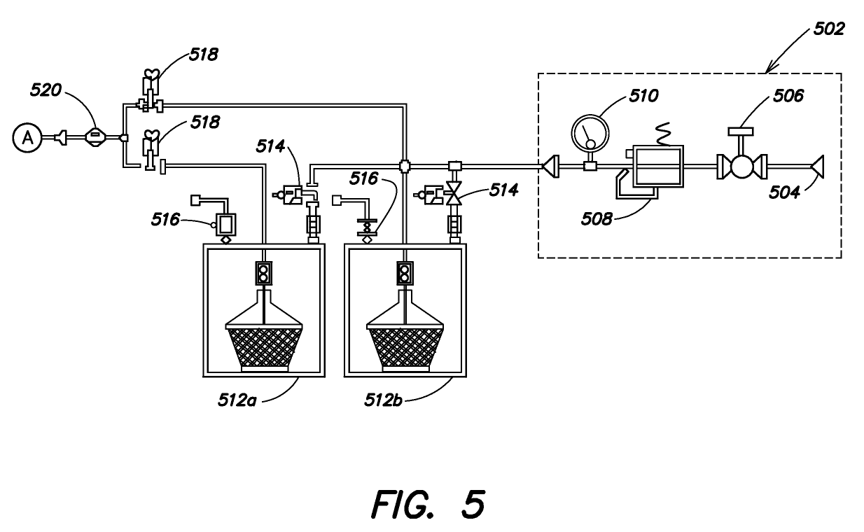

FIG. 5 depicts a schematic diagram of a portion of an embodiment of the present invention including a preferable fluid delivery mechanism. A purge gas (e.g., air, N2, etc.) may be flowed from a supply center 504, which may comprise a gas supply 504, a shut-off valve 506, a pressure control device 508, and a gauge 510. Gas from supply center 504 may be flowed to ink reservoirs 515a and 514B through valves 514. Reservoirs 515a-b may be vented via check valves 516. Ink from ink reservoirs 515a-b may be flowed through valves 518 and past flow meter 520.

Supply center 504 may be similar to, component of, and/or replacement for purge control unit 168 of FIG. 4A. Gas supply 504 may be any appropriate supply including a house gas system or gas tank. Shut-off valve 506 may be a ball valve, a valve such as valve 506 discussed above with respect to FIG. 4A, or any other appropriate valve.

Ink reservoirs 515a-b may be similar to, component of, and/or replacement for ink reservoirs 138, 140, 142 of FIGS. 1B and 4A. Reservoirs 515a-b may contain the same color ink and may be used simultaneously, alternately, or in replacement of one another. Though depicted here as two reservoirs, it is understood that any number of reservoirs (e.g., 1, 3, 4, 5, etc.) may be used and the reservoirs 515a-b may contain one or more colors of ink. In such cases where ink reservoirs 515a-b contain the same color ink, it is understood that each ink reservoir 615a-b may correspond to an individual print head 430a, 430b, 430c of FIG. 4B or may be used communally for multiple print heads.

In operation, fluid may be delivered via fluid delivery mechanisms. Specifically, a gas (e.g., hydrogen, nitrogen, filtered air, etc.) is flowed from the gas supply 504 of the supply center 504 through the shut-off valve 506, pressure control valve 608, and gauge 510 to the ink reservoirs 515a-b. The gas from the supply center 504 exerts a positive pressure on the ink reservoirs 515a-b. Gas pressure from the supply center 504 may be controlled and/or shut off via valves 514. Similarly, the pressure inside the reservoirs 515a-b may be controlled and/or exhausted using check valves 516.

The pressure exerted on the reservoirs 515a-b may cause ink to be flowed (e.g., via tubes 182 of FIGS. 1B and 4A) through valves 518 and past flow meter 520, which may be used to control and/or monitor ink flow pressure. Ink may then be flowed to the inkjet print heads 430a, 430b, 430c of FIG. 4B through line A (e.g., in the same way as in FIG. 4A), for example.

It may be understood that any appropriate gas pressure devices may be used as a fluid delivery mechanism. For example, the embodiment of FIG. 5 may utilize more or less valves, meters, sensors, etc. than described herein. Additionally, it may be understood that any other suitable arrangement wherein gas pressure is utilized to facilitate the flow of fluids within the above described systems and/or apparatus may be used.

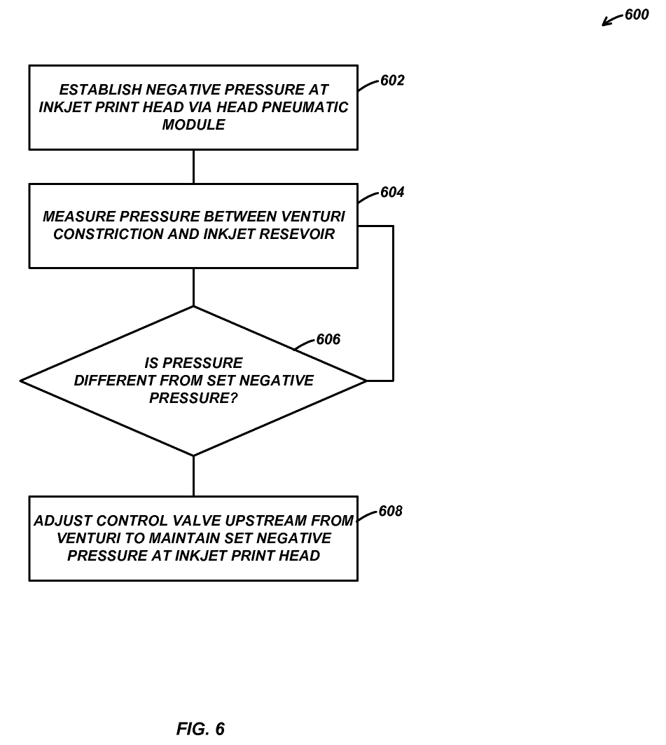

FIG. 6 depicts a block diagram of an exemplary method 600 for controlling the pressure in an ink reservoir.

In step 602, gas is pumped from purge control unit 168 or gas supply center 504 through head pneumatic module 440 to establish a negative pressure at the inkjet print heads 430a, 430b, 430c.

In step 604, the pressure in the suction lines leading from inkjet reservoirs 535A, 534B, 432c to the constriction 445a in venturi 442 may be measured by vacuum sensor 444.

In step 606, it is determined if this pressure is different from a set negative pressure. If the pressure is different from the set negative pressure, then step 608 is executed. If the pressure is not different from the set negative pressure, then step 604 is executed.

In step 608, control valve 446 upstream from venturi 442 is adjusted to maintain the set negative pressure inkjet print heads 430a, 430b, 430c.

The foregoing description discloses only exemplary embodiments of the invention; modifications of the above disclosed methods and apparatus which fall within the scope of the invention will be readily apparent to those of ordinary skill in the art. For example, the present invention allows precise control of the meniscus pressure of the inkjet head with a quick response time. This allows the generation of drops with accurate and repeatable inkjet drop volume. In alternative embodiments, indirect control of meniscus pressure using a regulator located relatively far from the print head and without directly monitoring the meniscus pressure at the ink reservoir was found to impact the response due to the long tube conductance. Consequently, in some embodiments of the present invention, meniscus pressure control units are installed at the each inkjet head, e.g., close enough to get a quick response and accurate pressure feedback. Meniscus pressure control unit may include a purge pressure line and is able to switch meniscus pressure (e.g., 0.5″ to 2″ H20 negative pressure) to positive pressure (e.g., 5 psi positive pressure) to purge ink stored in the reservoir and in the inkjet head. In some embodiments, a degas module for the ink and the ink reservoir (e.g., for removing gas) may be integrated in as part of head pneumatic module. Thus, the present invention improves accuracy of meniscus pressure, improves the response time of meniscus pressure control, and allows generation of repeatable inkjet drops (e.g., size, shape, volume, density, etc.) The present invention not only applies to manufacturing color filters printed of flat panel displays, the present invention may be use for depositing OLED, spacer balls for LCD, metal layer printing for solar panel, etc.

Accordingly, while the present invention has been disclosed in connection with specific embodiments thereof, it should be understood that other embodiments may fall within the spirit and scope of the invention, as defined by the following claims.

The invention claimed is:

1. An apparatus for use with an inkjet delivery system comprising:
a negative pressure mechanism proximate to an inkjet print head, adapted to apply a negative pressure on ink residing at the inkjet print head;
a controller coupled to the negative pressure mechanism, adapted to controllably set the negative pressure on the ink at the inkjet print head.

2. The apparatus of claim 1, wherein the negative pressure mechanism includes a venturi having a constriction.

3. The apparatus of claim 2, further comprising:
a control valve coupled to the venturi, adapted to control the flow of gas from a high-pressure gas line, through the venturi.

4. The apparatus of claim 3 further comprising:
a vacuum sensor coupled to the constriction of the venturi and adapted to measure a pressure at the constriction.

5. The apparatus of claim 4, wherein the controller is coupled to the vacuum sensor so as to receive a signal indicative of the pressure measured at the constriction, the controller controlling the control valve based on the measured pressure.

6. The apparatus of claim 5, further comprising:
a shutoff valve coupled to the constriction of the venturi, adapted to restrict the flow of gas through a gas suction line to the constriction of the venturi.

7. An inkjet printing system comprising:
a plurality of inkjet print heads; and
a head pneumatic module proximate to and coupled to the plurality of print heads, including a negative pressure mechanism adapted to apply a negative pressure on ink residing at the inkjet print head; and
a controller coupled to the negative pressure mechanism of the head pneumatic module, adapted to controllably set the negative pressure on the ink at the inkjet print head.

8. The system of claim 7, further comprising:
a plurality of inkjet reservoirs adapted to contain ink, each having a first conduit coupled to the head pneumatic module for establishing a negative pressure in the respective reservoir, and each having a second conduit in fluid communication with one of the plurality of inkjet print heads.

9. The system of claim 8, wherein the negative pressure mechanism includes a venturi having a constriction.

10. The system of claim 9, wherein the negative pressure mechanism includes a control valve coupled to the venturi, adapted to control the flow of gas from a high-pressure gas line, through the venturi.

11. The system of claim 10, wherein the head pneumatic module includes a vacuum sensor coupled to the constriction of the venturi and adapted to measure a pressure at the constriction.

12. A method of controlling pressure on ink at an inkjet print head in an inkjet printing system, comprising:
producing a negative pressure on the ink at the inkjet print head from a location proximate to the inkjet print head;
measuring the negative pressure produced; and
adjusting the negative pressure based on the measurement of the negative pressure to maintain a set negative pressure.

13. The method of claim 12, wherein the negative pressure is set to produce a uniform size of ink drop from the inkjet print head.

14. The method of claim 12, wherein the negative pressure is set to produce suction sufficient for preventing leakage from the print head.

15. The method of claim 12, wherein the negative pressure is produced, using a venturi having a constriction.

16. The method of claim 15, further comprising:
measuring the negative pressure at the constriction of the venturi.

17. The method of claim 12, wherein the negative pressure is generated at a head pneumatic module proximate to the inkjet print head.
